(19) United States
(12) Patent Application Publication
(10) Pub. No.: US 2026/0369245 A1
(43) Pub. Date: Nov. 19, 2026

(54) DISPLAY DEVICE, DRIVING METHOD OF DISPLAY DEVICE, AND ELECTRONIC DEVICE

(71) Applicant: Sharp Kabushiki Kaisha, Osaka (JP)

(72) Inventors: Shunsuke ISHII, Sakai City (JP); Daiji KITAGAWA, Sakai City (JP); Yoshitaka ORITA, Sakai City (JP); Jin MIYAZAWA, Sakai City (JP); Daisuke SUEHIRO, Sakai City (JP)

(21) Appl. No.: 19/642,884

(22) Filed: Apr. 9, 2026

(30) Foreign Application Priority Data
May 16, 2025 (JP) 2025-082716

(51) Int. Cl. G09G 3/36

(52) U.S. Cl. CPC G09G 3/3677; G09G 3/3648; G09G 2300/0426; G09G 2310/08; G09G 2340/0435

(57) ABSTRACT

A display device includes a display panel including a pixel electrode and a common electrode configured to form an electrical field between the pixel electrode and the common electrode, a gate driver configured to supply a gate signal to a gate line of the display panel, a source driver configured to supply a pixel voltage to the pixel electrode by sequentially supplying a source signal to a source line of the display panel, and a control circuit configured to control the gate driver and the source driver. When updating display of a partial area of the display panel, the control circuit controls driving of the gate driver to scan the gate lines from the upper end of the display panel to the lower end of the partial area and not to scan the gate lines below the lower end of the partial area.

### CROSS-REFERENCE TO RELATED APPLICATIONS

This application claims the benefit of priority to Japanese Patent Application Number 2025-082716 filed on May 16, 2025. The entire contents of the above-identified application are hereby incorporated by reference.

### BACKGROUND

### Technical Field

The disclosure relates to a display device, a driving method of a display device, and an electronic device.

JP 2015-121732 A discloses a drive circuit for a display device, which includes a vertical direction driving unit provided corresponding to each gate line, including a vertical direction shift register operating in synchronization with a vertical direction clock, and outputting, for each gate line, a V gate signal for activating the gate line according to a logical product of a vertical control signal for switching whether to activate the gate line and an output of the vertical shift register, and a horizontal direction driving unit provided corresponding to each data line, including a horizontal direction shift register operating in synchronization with a horizontal direction clock, and outputting, for each data line, an H gate signal for activating the data line according to a logical product of a horizontal control signal for switching whether to activate the data line and an output of the horizontal shift register and enables partial driving of each of the gate line and the data line.

### SUMMARY

In JP 2015-121732 A, the vertical direction driving unit that outputs the V gate signal for activating a gate line according to the logical product of the vertical control signal and the output of the vertical shift register, and the horizontal direction driving unit that outputs the H gate signal for activating a data line according to the logical product of the horizontal control signal and the output of the horizontal shift register are required. Thus, it is necessary to add a circuit for the partial driving, which causes a problem of an increase in a circuit scale.

An object of an aspect of the disclosure is to provide a technique capable of supporting the partial driving without increasing the circuit scale.

In order to solve the above problems, a display device according to an aspect of the disclosure includes a display panel including a pixel electrode and a common electrode configured to form an electrical field between the pixel electrode and the common electrode, a gate driver configured to supply a gate signal to a gate line of the display panel, a source driver configured to supply a pixel voltage to the pixel electrode by sequentially supplying a source signal to a source line of the display panel, and a control circuit configured to control the gate driver and the source driver, in which when updating display of a partial area of the display panel, the control circuit controls driving of the gate driver to scan the gate lines from an upper end of the display panel to a lower end of the partial area and not to scan the gate lines below the lower end of the partial area.

According to an aspect of the disclosure, it is possible to support the partial driving without increasing the circuit scale.

### BRIEF DESCRIPTION OF DRAWINGS

The disclosure will be described with reference to the accompanying drawings, wherein like numbers reference like elements.

FIG. 1 is a diagram illustrating a configuration example of a display device according to an embodiment of the disclosure.

FIG. 2 is a circuit diagram illustrating a configuration of a pixel.

FIG. 3 is a diagram for describing a principle of a display device according to an embodiment of the disclosure.

FIG. 4 is a diagram illustrating an example of a unit circuit constituting a gate driver.

FIG. 5 is a diagram for describing entire screen driving.

FIG. 6 is a timing chart in a case of performing the entire screen driving.

FIG. 7 is a diagram for describing partial driving.

FIG. 8 is an example of a timing chart in a case of performing the partial driving.

FIG. 9 is another example of the timing chart in the case of performing the partial driving.

FIG. 10 is still another example of the timing chart in the case of performing the partial driving.

FIG. 11 is diagrams each for describing an increase in a drive capability of a transistor.

FIG. 12 diagrams each for describing an increase in a drive capability of a transistor.

FIG. 13 is a diagram illustrating a configuration example of a display device according to an embodiment of the disclosure.

### DESCRIPTION OF EMBODIMENTS

Hereinafter, an embodiment of the disclosure will be described in detail with reference to the drawings. In the description of the drawings, the same or substantially equivalent configurations are denoted by the same reference numerals and signs, and detailed descriptions thereof will be omitted.

### First Embodiment

In a notebook personal computer (PC), in addition to the entire screen display, there are many uses in which a moving picture content is displayed on only a part of a screen in a Window mode and a still image content is displayed on the other part. Not only when displaying the moving picture content, but also in a scene of use in business, there are many cases where display of a part of the screen is updated by text creation software, spreadsheet software, or the like, and the other area continues to display substantially the same screen.

In such a notebook PC or the like in which there are many such uses, in the related art, even when the display is updated in a part of the screen, update of the entire area (panel: scanning of gate lines) is performed, and thus, there is a limit to reduction in power consumption. However, recently, reduction in power is performed by providing an area having a different refresh rate in the screen. This sort of a display method is referred to as the partial driving.

### Configuration Example of Display Device 100

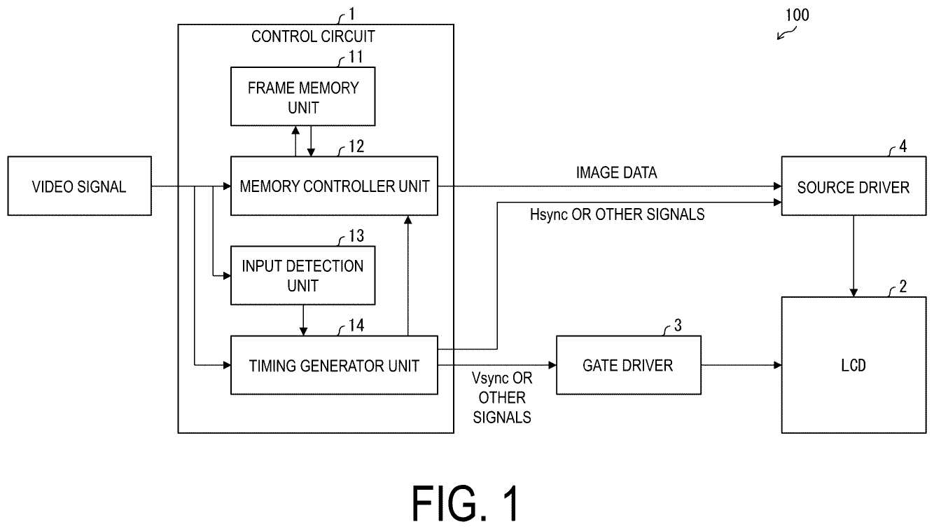

FIG. 1 is a diagram illustrating a configuration example of a display device according to an embodiment of the disclosure. As illustrated in FIG. 1, the display device 100 includes a control circuit 1, a liquid crystal display (LCD) 2, a gate driver 3, and a source driver 4. A device including the display device 100 and a display control device such as a personal computer system 5 described later is referred to as an electronic device.

The display device 100 is, for example, a display monitor, a personal computer, a tablet terminal, a smartphone, a smartwatch, or a television device. The display device 100 is, for example, a liquid crystal display. The control circuit 1 may be configured as a device integrated with the display device 100, or may be configured as a device separate from the display device 100.

The display device 100 may employ any driving method such as a fringe field switching (FFS) method, an in-plane-switching (IPS) method, a twisted nematic (TN) method, or a vertical alignment (VA) method. Hereinafter, a case where the display device 100 is a liquid crystal display device will be described, but the display device 100 is not limited thereto.

The gate driver 3 supplies a gate signal to a gate line of the LCD 2. The source driver 4 supplies pixel voltages to the pixel electrodes by sequentially supplying source signals to the source lines in the LCD 2.

The number of a plurality of the gate lines is a natural number m. The number of a plurality of the source lines is a natural number n. The plurality of gate lines are disposed to intersect the plurality of source lines.

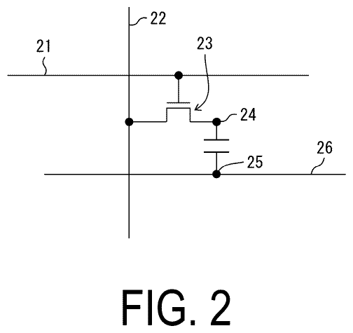

FIG. 2 is a circuit diagram illustrating a configuration of a pixel. The LCD 2 includes a pixel electrode 24 and a common electrode that forms an electrical field between the pixel electrode 24 and the common electrode. As illustrated in FIG. 2, a thin film transistor 23 and the pixel electrode 24 are disposed in each of regions(pixels) defined by a plurality of gate lines 21 and a plurality of source lines 22. The gate line 21 is connected to a gate electrode of the thin film transistor 23. The source line 22 is connected to a source electrode of the thin film transistor 23.

The pixel electrode 24 is connected to a drain electrode of the thin film transistor 23. A common electrode 25 that forms the electrical field between the common electrode 25 and the pixel electrode 24 is provided to the LCD 2. The common electrode 25 is disposed (provided in common) to correspond to a plurality of the pixel electrodes 24. A common wiring line 26 that connects the common electrode 25 and the gate driver 3 to each other is provided to the LCD 2.

It is possible to perform multicolor display by transmitting light of a BL provided on the back surface of the LCD 2 (not illustrated) depending on a transmission state of a pixel TFT driven by the gate driver 3 and the source driver 4 or by a color filter and a black matrix (BM) disposed on one of two glass substrates sandwiching a liquid crystal, the one including no drive bus line and no source line.

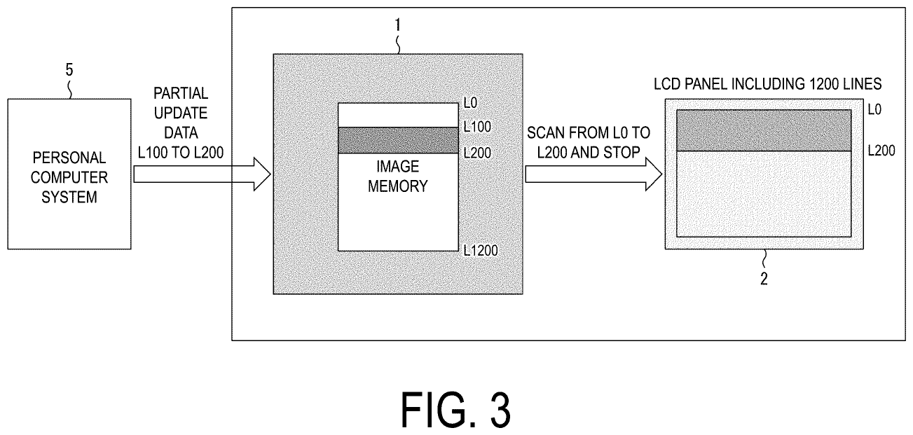

FIG. 3 is a diagram for describing a principle of a display device according to an embodiment of the disclosure. As illustrated in FIG. 3, when partial update data is input from the personal computer system 5 to the control circuit 1, image data in a corresponding area of an image memory (a frame memory unit 11 in FIG. 1) is updated. The partial update data is, for example, image data corresponding to lines L100 to L200. A description will be made with the number of lines of the LCD 2 being 1200 lines, and a partial area whose display is updated being lines L100 to L200.

When the image data in the image memory is updated, the control circuit 1 controls driving of the gate driver 3 so as to scan the gate lines from an upper end (L1) of the LCD (display panel) 2 to a lower end (L200) of the partial area and not to scan the gate lines (L201 to L1200) below the lower end of the partial area. In this manner, since the gate lines (L201 to L1200) below the lower end of the partial area are not scanned, it is possible to support the partial driving without increasing the circuit scale, and to achieve low power consumption.

The control circuit 1 generates and outputs signals necessary for driving the gate driver 3 and the source driver 4, based on the video signal output from the personal computer system 5. The control circuit 1 controls a refresh rate that is a frequency at which an image displayed on the LCD 2 is rewritten.

The personal computer system 5 is equipped with a central processing unit (CPU) or a graphical processing unit (GPU), and supplies image data corresponding to the partial area and image data corresponding to the entire screen to the display device 100. The personal computer system 5 outputs the entire screen data to the control circuit 1 when the entire screen data is updated, and outputs only the partial update data to the control circuit 1 when only the partial update data is updated.

The control circuit 1 controls the gate driver 3 and the source driver 4 so as to supply the pixel voltages at a partial area refresh rate to the pixel electrodes corresponding to the gate lines from the upper end of the LCD 2 to the lower end of the partial area. The control circuit 1 controls the gate driver 3 and the source driver 4 so as to supply the pixel voltages at an entire screen refresh rate that is a frequency lower than the partial area refresh rate to the pixel electrodes corresponding to the gate lines below the lower end of the partial area.

The control circuit 1 includes the frame memory unit 11, a memory controller unit 12, an input detection unit 13, and a timing generator unit 14. The frame memory unit 11 retains the entire screen data and the partial update data received from the personal computer system 5.

The memory controller unit 12 writes the entire screen data or the partial update data received from the personal computer system 5 into an appropriate region of the frame memory unit 11. When the memory controller unit 12 receives the entire screen data from the personal computer system 5, the memory controller unit 12 updates the display data for the entire screen in the frame memory unit 11. When the memory controller unit 12 receives partial update data from the personal computer system 5, the memory controller unit 12 updates only the display data of the corresponding area in the frame memory unit 11.

The memory controller unit 12 reads the entire screen data or the partial update data (including image data above the partial update data) from the frame memory unit 11, and outputs the read data as the image data to the source driver 4. When a frame corresponding to the partial area refresh rate is displayed on the LCD 2, only the partial update data (including the image data above the partial update data) is read from the frame memory unit 11 and the read data is output to the source driver 4. When a frame corresponding to the entire screen refresh rate is displayed on the LCD 2, the entire screen data is read from the frame memory unit 11 and the read data is output to the source driver 4.

The input detection unit 13 receives a video signal (image data) from the personal computer system 5, and determines whether the video signal is a video signal corresponding to the partial area or a video signal corresponding to the entire screen. Then, in the case of the video signal corresponding to the partial area, the input detection unit 13 determines an area in which data is updated, and outputs the area to the timing generator unit 14.

When the input detection unit 13 determines that the video signal corresponds to the entire screen, the timing generator unit 14 generates a horizontal synchronization signal (Hsync), a vertical synchronization signal (Vsync), and other control signals so as to scan all the gate lines in the LCD 2, and outputs the generated signals to the gate driver 3 and the source driver 4.

When the input detection unit 13 determines that the video signal corresponds to the partial area, the timing generator unit 14 generates the horizontal synchronization signal (Hsync), the vertical synchronization signal (Vsync), and other control signals so as to scan the gate lines from the upper end of the LCD 2 to the lower end of the partial area and not to scan the gate lines below the lower end of the partial area, and outputs the generated signals to the gate driver 3 and the source driver 4.

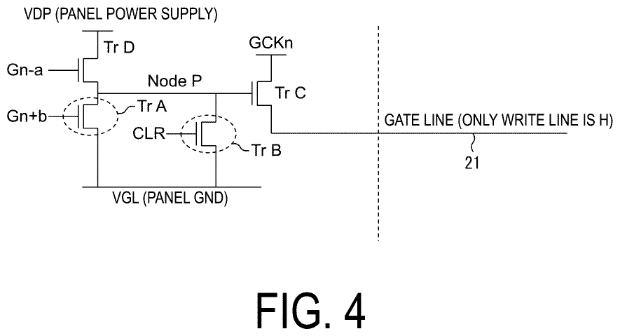

FIG. 4 is a diagram illustrating an example of a unit circuit constituting the gate driver 3. As illustrated in FIG. 4, the unit circuit is provided corresponding to each of the gate lines 21, and includes a charge retention node (NodeP) that retains charges for outputting a gate clock (GCKn) signal as a scanning signal to the corresponding gate line 21, and transistors TrA to TrD.

The transistor TrA includes a drain terminal to which the charge retention node (NodeP)is connected, a gate terminal to which a Gn+b signal line is connected, and a source terminal to which a low-voltage power supply line (panel GND) is connected (grounded). The Gn+b signal is a signal that becomes an H level b lines before the corresponding gate line and turns on the transistor TrA.

The transistor TrB includes a drain terminal to which the charge retention node (NodeP) is connected, a gate terminal to which a CLR signal line is connected, and a source terminal to which a low-voltage power supply line (panel GND) is connected (grounded). The CLR signal is a signal for discharging the charge retention node (NodeP).

The transistor TrC includes a drain terminal to which a gate clock (GCKn) signal is connected, a gate terminal to which the charge retention node (NodeP) is connected, and a source terminal to which the corresponding gate line 21 is connected. The transistor TrC outputs a gate clock signal as a scanning signal to the corresponding gate line 21.

The transistor TrD includes a drain terminal to which a panel power supply (VDP) is connected, a gate terminal to which a Gn-a signal line is connected, and a source terminal to which the charge retention node (NodeP) is connected. The Gn-a signal is a signal that becomes the H level a lines before the corresponding gate line and turns on the transistor TrD.

The timing generator unit 14 outputs a gate clock signal as a scanning signal to the corresponding gate line 21 at an appropriate timing by outputting the Gn-a signal and the Gn+b signal to the unit circuit corresponding to each gate line 21. The timing generator unit 14 outputs the Gn-a signal and the Gn+b signal so as to turn off the TrD when turning on TrA.

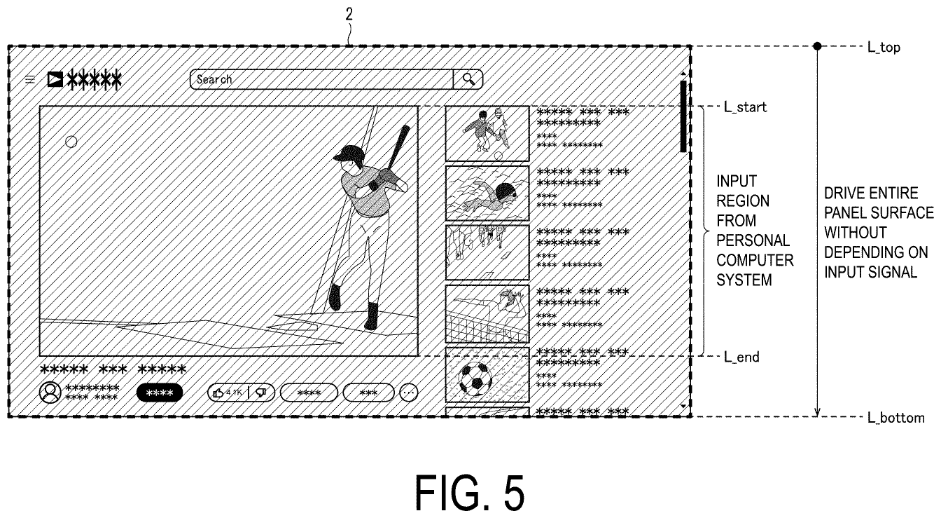

FIG. 5 is a diagram for describing the entire screen driving. In FIG. 5, the upper end of the LCD 2 is L_top, and the lower end of the LCD 2 is L_bottom. The upper end of the partial area is L_start, and the lower end of the partial area is L_end. Even when the image data of the partial area of L_start to L_end is updated, the gate driver 3 performs driving so as to scan the gate lines 21 corresponding to the entire screen when driving the entire screen.

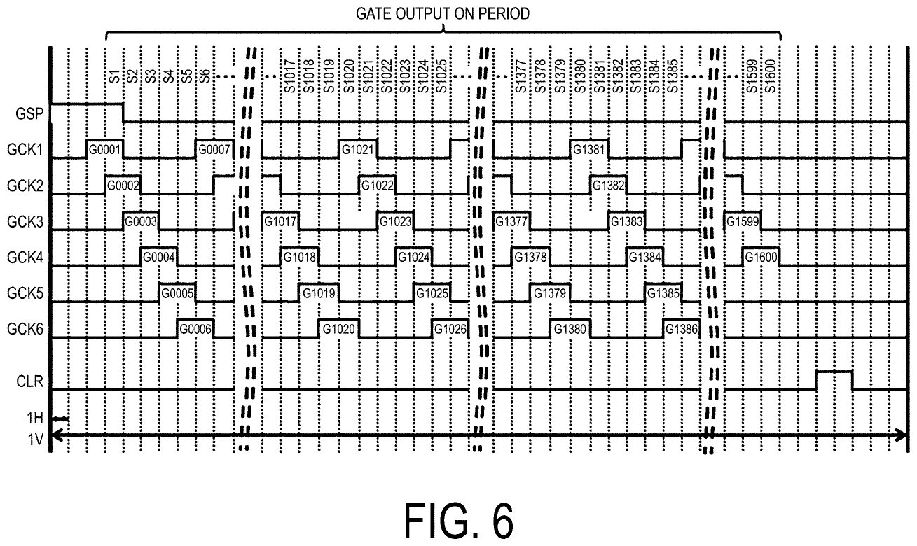

FIG. 6 is a timing chart in a case of performing the entire screen driving. In FIG. 6, each of S1 to S1600 corresponds to one horizontal period. As illustrated in FIG. 6, the timing generator unit 14 sequentially outputs gate clock signals GCK1 to GCK6 to the gate driver 3.

The timing generator unit 14 outputs the Gn-a signal and the Gn+b signal to the unit circuit corresponding to each gate line 21 at an appropriate timing. For example, the timing generator unit 14 outputs the Gn-a signal and the Gn+b signal to the corresponding unit circuit so as to output the gate clock (GCK1) signal as a scanning signal (G0001) to the gate line 21 corresponding to the line L1.

As illustrated in FIG. 6, the timing generator unit 14 controls driving of the gate driver 3 so as to scan the gate lines from the upper end (L1) of the LCD (display panel) 2 to the lower end (L1600) of the LCD 2. The timing generator unit 14 discharges the charges of the charge retention node (NodeP) by outputting the CLR signal after the scanning of the gate line at the lower end (L1600) of the LCD 2 is completed.

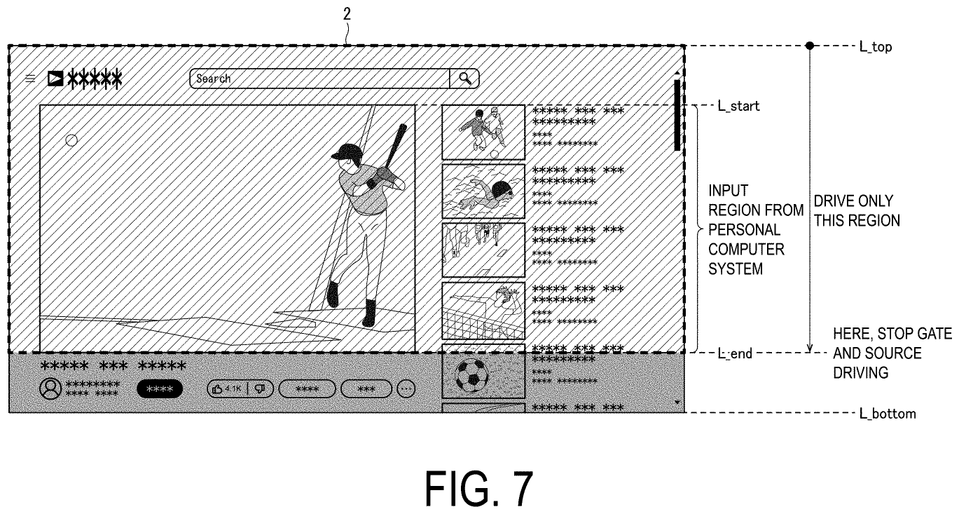

FIG. 7 is a diagram for describing the partial driving. In FIG. 7, the upper end of the LCD 2 is L_top, and the lower end of the LCD 2 is L_bottom. The upper end of the partial area is L_start, and the lower end of the partial area is L_end. When updating the image data in the partial area from L_start to L_end, the gate driver 3 performs driving so as to scan the gate lines from the upper end (L_top) of the LCD 2 to the lower end (L_end) of the partial area and not to scan the gate lines below the lower end (L_end) of the partial area.

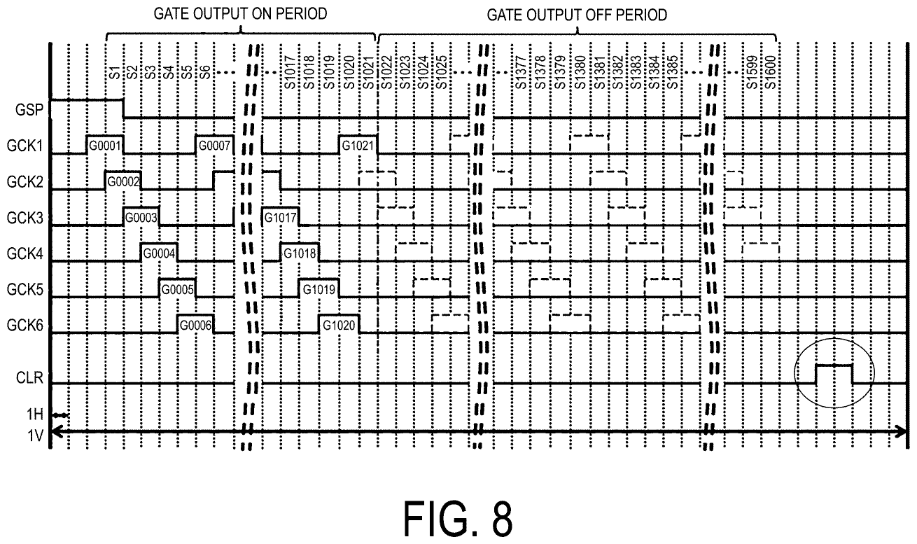

FIG. 8 is an example of a timing chart in a case of performing the partial driving. In FIG. 8, each of S1 to S1600 corresponds to one horizontal period. As illustrated in FIG. 8, the timing generator unit 14 sequentially outputs the gate clock signals GCK1 to GCK6 to the gate driver 3.

The timing generator unit 14 outputs the Gn-a signal and the Gn+b signal to the unit circuit corresponding to each gate line 21 at an appropriate timing. For example, the timing generator unit 14 outputs the Gn-a signal and the Gn+b signal to the corresponding unit circuit so as to output the gate clock (GCK1) signal as a scanning signal (G0001) to the gate line 21 corresponding to the line L1.

As illustrated in FIG. 8, the timing generator unit 14 controls driving of the gate driver 3 so as to scan from the gate line (G0001) at the upper end L1 of the LCD (display panel) 2 to the gate line (G1021) at the lower end L_end of the partial area. Then, the timing generator unit 14 controls driving of the gate driver 3 so as not to scan the gate lines (G1022 to G1600) below the lower end L_end of the partial area.

The timing generator unit 14 discharges the charges of the charge retention node (NodeP) by outputting the H level to the CLR signal after the scanning of the gate line at the lower end (L1600) of the LCD 2 is completed.

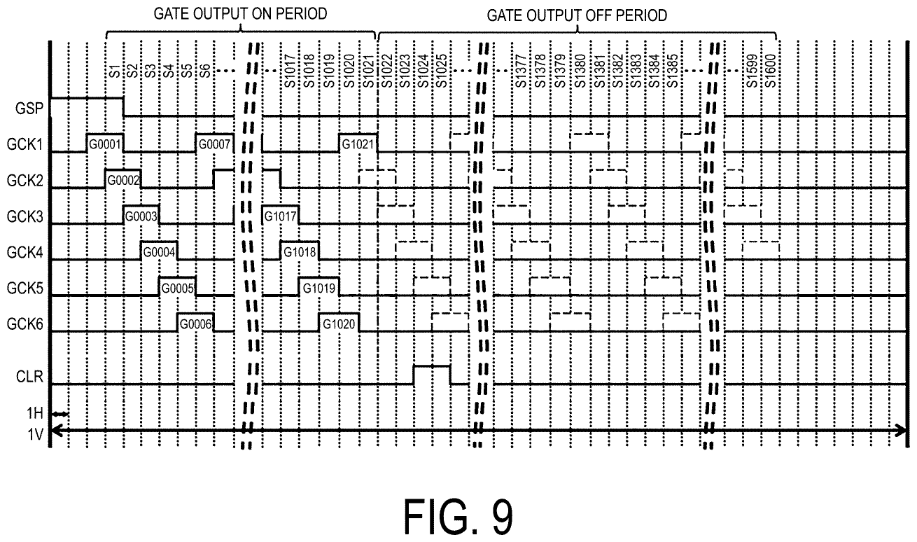

FIG. 9 is another example of the timing chart in the case of performing the partial driving. As compared with FIG. 8, only the output timing of the CLR signal by the timing generator unit 14 is different.

As illustrated in FIG. 9, the timing generator unit 14 controls driving of the gate driver 3 so as to scan from the gate line (G0001) at the upper end L1 of the LCD (display panel) 2 to the gate line (G1021) at the lower end L_end of the partial area. Then, the timing generator unit 14 controls driving of the gate driver 3 so as not to scan the gate lines (G1022 to G1600) below the lower end L_end of the partial area.

The timing generator unit 14 controls driving of the gate driver 3 so as to scan the gate line (G1021) at the lower end L_end of the partial area, and then outputs the H level for two horizontal periods to the CLR signal at a timing S1024 after two horizontal periods. In this manner, the reason why the CLR signal is set to the H level at the timing after two horizontal periods is to discharge the gate line by connecting the GCKn at the L level to the gate line before the charge retention node (NodeP) is discharged, that is, while the TrC is on.

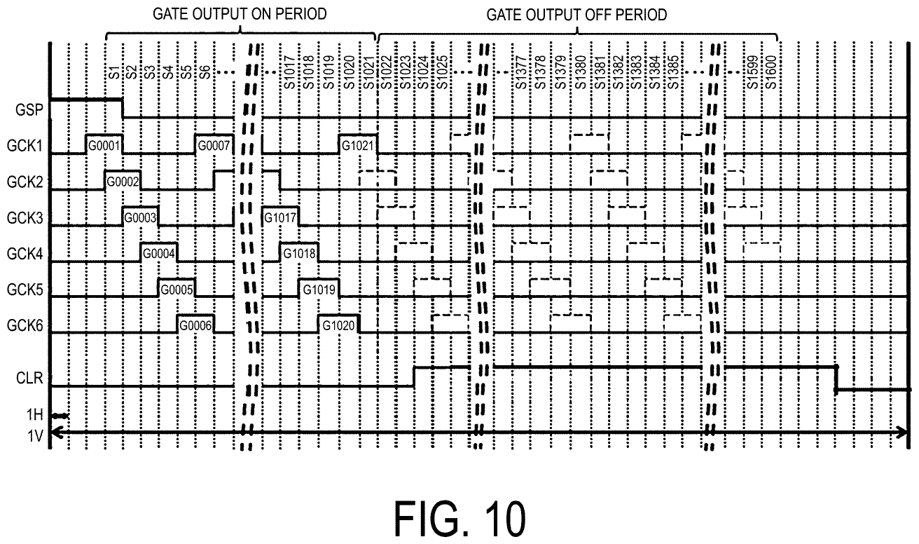

FIG. 10 is still another example of the timing chart in the case of performing the partial driving. As compared with FIG. 8, only the output timing of the CLR signal by the timing generator unit 14 is different.

As illustrated in FIG. 10, the timing generator unit 14 controls driving of the gate driver 3 so as to scan from the gate line (G0001) at the upper end L1 of the LCD (display panel) 2 to the gate line (G1021) at the lower end L_end of the partial area. Then, the timing generator unit 14 controls driving of the gate driver 3 so as not to scan the gate lines (G1022 to G1600) below the lower end L_end of the partial area.

The timing generator unit 14 controls driving of the gate driver 3 so as to scan the gate line (G1021) at the lower end L_end of the partial area, and then outputs the H level to the CLR signal at a timing S1024 after two horizontal periods, and continues to output the H level to the CLR signal until the frame in completed (until the next frame starts). In this manner, by increasing the period of the H level of the CLR signal, the charges of the charge retention node (NoreP) can be completely discharged even when a drive capability of the transistor TrB is low.

However, even when the time of the H level of the CLR signal is increased, for example, in the case of the partial driving in which only the final S1600 line is not driven, the time of the H level of the CLR signal increases only by one horizontal period.

Thus, a reasonable size of the TrB is first determined (when the size increases to some extent, the panel size is not affected in terms of layout), and when the time of the H level of the CLR signal necessary for the reasonable size is, for example, five horizontal periods, the partial driving is not performed after 1600−3=1597 (the time of the H level of the CLR signal becomes five horizontal periods) (that is, 1598 to 1600). Thus, a discharge time of the five horizontal periods can certainly be ensured. In the case where the partial driving is not performed, there is no problem since the charge retention node (NodeP) is discharged by the TrA as usual.

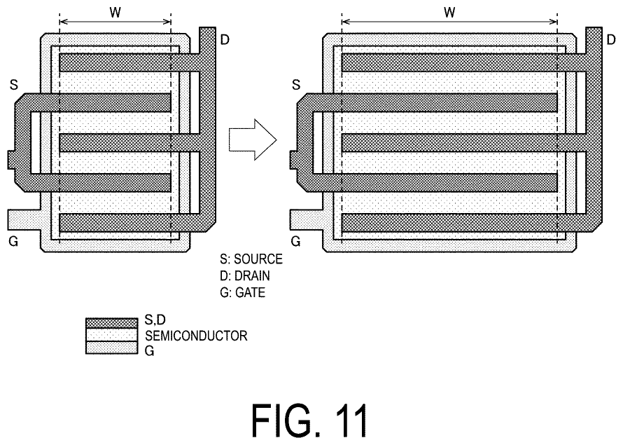

FIG. 11 is diagrams each for describing an increase in a drive capability of a transistor. The CLR signal has two roles, the first is to reset the circuit in the LCD during the normal driving of the LCD, and the second is to set the CLR signal to the H level for a long time, for example, during 10 ms when the display is off to completely discharge the charges of the charge retention node (NoreP) and safely complete the display.

That is, the normal TrB does not have the drive capability to discharge the NodeP during a time from stop of scanning in the middle of display to the start of the next scanning, for example, during 0.1 ms. In order to achieve this, in the present embodiment, the size of the TrB is increased as illustrated in FIG. 11, and is designed, for example, to be the same size as the TrA, or to be a size that can be discharged at, for example, 0.1 ms. Thus, the stop in the middle is realistic for the first time. As compared with the addition of a circuit for the partial driving in the related art, the partial driving can be achieved only by increasing the size of the TrB in the present embodiment.

As illustrated in FIG. 11, the drive capability of the TrB can be increased by increasing a width W of an overlapping portion of a drain (D) and a source(S). For example, the width W is set to 5 μm in the related art, but is set to 20 μm or more in the present embodiment. Since this number varies greatly depending on a performance of a semiconductor, the width W is appropriately from about 20 μm to about several hundred μm. That is, in the TrB, the width of the overlapping portion of the source and the drain in the process is defined so that the charges of the charge retention node (NodeP) are completely discharged by the CLR signal.

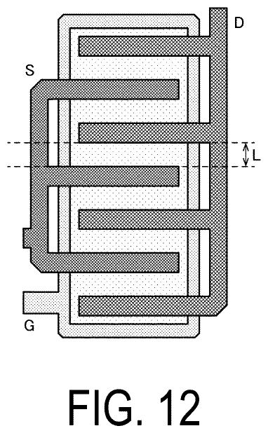

FIG. 12 is a diagram for describing another method of increasing the drive capability of the transistor. As a parameter related to the drive capability of the transistor, there is a distance L between a line of the source(S) and a line of the drain (D), and the drive capability can be changed by changing the distance L. However, since there is an appropriate distance for each process, the distance L cannot be changed so much. Thus, as illustrated in FIG. 12, by increasing the number of sources(S) and drains (D), the same effect as that of increasing the width W can be obtained.

### Operational Effects

As described above, according to an embodiment of the disclosure, the following operational effects are obtained.

When updating the display of the partial area of the LCD (display panel) 2, the control circuit 1 controls driving of the gate driver 3 so as to scan the gate lines from the upper end of the LCD (display panel) 2 to the lower end of the partial area and not to scan the gate lines below the lower end of the partial area. Thus, it is possible to reduce power consumption without adding the circuit for the partial driving.

The control circuit 1 outputs the H level to the clear signal during a period from the completion of the scanning of the gate lines 21 up to the lower end of the partial area to the end of the display of the current frame to cause the transistor TrB to discharge the charge retention node (NodeP). Thus, the charge retention node (NodeP) can be discharged so that a malfunction does not occur.

The control circuit 1 continuously outputs the H level to the clear signal during a period from the completion of the scanning of the gate lines 21 up to the lower end of the partial area to the start of the display of the next frame to cause the transistor TrB to discharge the charge retention node (NodeP). Thus, the charge retention node (NodeP) can be discharged so that a malfunction does not occur.

In the transistor TrB, the width W of the overlapping portion of the source(S) and the drain (D) in the process is determined so that the charges of the charge retention node (NodeP) are completely discharged by the clear signal. Thus, the charge retention node (NodeP) can be discharged so that a malfunction does not occur.

### Second Embodiment

Configuration Example of Display Device 100A

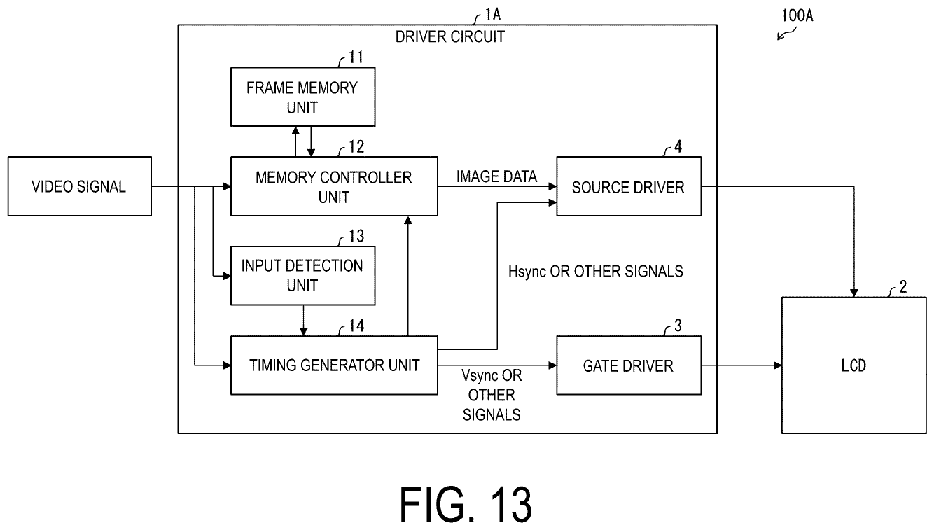

FIG. 13 is a diagram illustrating a configuration example of a display device 100A according to an embodiment of the disclosure. As illustrated in FIG. 13, the display device 100A includes a driver circuit 1A and the LCD 2. The driver circuit 1A includes the frame memory unit 11, the memory controller unit 12, the input detection unit 13, the timing generator unit 14, the gate driver 3, and the source driver 4.

The driver circuit 1A has a configuration in which the gate driver 3 and the source driver 4 are added to the control circuit 1 in the first embodiment illustrated in FIG. 1. The other configurations are the same as those of the first embodiment, and thus the detailed description thereof will not be repeated.

As described above, in the present embodiment, the driver circuit 1A is configured by one chip including the control circuit 1, the gate driver 3, and the source driver 4 illustrated in FIG. 1, and thus the circuit portion can be downsized.

### Supplement

At least the following aspects are described in the disclosure.

### First Aspect

A display device according to a first aspect of the disclosure includes a display panel including a pixel electrode and a common electrode configured to form an electrical field between the pixel electrode and the common electrode, a gate driver configured to supply a gate signal to a gate line of the display panel, a source driver configured to supply a pixel voltage to the pixel electrode by sequentially supplying a source signal to a source line of the display panel, and a control circuit configured to control the gate driver and the source driver, in which when updating display of a partial area of the display panel, the control circuit controls driving of the gate driver to scan the gate lines from an upper end of the display panel to a lower end of the partial area and not to scan the gate lines below the lower end of the partial area.

### Second Aspect

In the display device according to a second aspect of the disclosure, in the first aspect, the gate driver includes a unit circuit provided corresponding to each of the gate lines, and the unit circuit includes a charge retention node configured to retain charges to output a gate clock signal to the corresponding gate line, a first transistor including a drain terminal connected to the gate clock signal, a gate terminal connected to the charge retention node, and a source terminal connected to the corresponding gate line, and a second transistor including a drain terminal connected to the charge retention node, a gate terminal connected to a clear signal for discharging the charges of the charge retention node, and a source terminal connected to a low-voltage power supply line.

### Third Aspect

In the display device according to a third aspect of the disclosure, in the second aspect, the control circuit outputs the clear signal to cause the second transistor to discharge the charge retention node during a period from the completion of the scanning of the gate lines to the lower end of the partial area to the completion of the display of the current frame.

### Fourth Aspect

In the display device according to a fourth aspect of the disclosure, in the second aspect, the control circuit continuously outputs the clear signal to cause the second transistor to discharge during a period from the completion of the scanning of the gate lines to the lower end of the partial area to start of the display of the next frame.

### Fifth Aspect

In the display device according to a fifth aspect of the disclosure, in any of the second to fourth aspects, a width of an overlapping portion of a source and a drain in a process is defined so that the charges of the charge retention node is completely discharged by the clear signal in the second transistor.

### Sixth Aspect

A driving method according to a sixth aspect of the disclosure is a driving method of the display device according to the first aspect.

### Seventh Aspect

An electronic device according to a seventh aspect of the disclosure includes the display device according to any of the first to fifth aspects, and a display control device configured to supply image data corresponding to a partial area and image data corresponding to the entire screen to the display device.

The disclosure is not limited to the embodiments described above, and various modifications may be made within the scope of the claims. Embodiments obtained by appropriately combining technical approaches disclosed in the different embodiments also fall within the technical scope of the disclosure.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a display panel including a pixel electrode and a common electrode configured to form an electrical field between the pixel electrode and the common electrode;
a gate driver configured to supply a gate signal to a gate line of the display panel;
a source driver configured to supply a pixel voltage to the pixel electrode by sequentially supplying a source signal to a source line of the display panel; and
a control circuit configured to control the gate driver and the source driver,
wherein when updating display of a partial area of the display panel, the control circuit controls driving of the gate driver to scan the gate lines from an upper end of the display panel to a lower end of the partial area and not to scan the gate lines below the lower end of the partial area.

2. The display device according to claim 1,
wherein the gate driver includes a unit circuit provided corresponding to each of the gate lines, and
the unit circuit includes a charge retention node configured to retain charges to output a gate clock signal to the corresponding gate line,
a first transistor including a drain terminal connected to the gate clock signal, a gate terminal connected to the charge retention node, and a source terminal connected to the corresponding gate line, and
a second transistor including a drain terminal connected to the charge retention node, a gate terminal connected to a clear signal for discharging the charges of the charge retention node, and a source terminal connected to a low-voltage power supply line.

3. The display device according to claim 2,
wherein the control circuit outputs the clear signal to cause the second transistor to discharge the charge retention node during a period from the completion of the scanning of the gate lines to the lower end of the partial area to the completion of the display of the current frame.

4. The display device according to claim 2,
wherein the control circuit continuously outputs the clear signal to cause the second transistor to discharge during a period from the completion of the scanning of the gate lines to the lower end of the partial area to start of the display of the next frame.

5. The display device according to claim 2,
wherein a width of an overlapping portion of a source and a drain in a process is defined, so that the charges of the charge retention node is completely discharged by the clear signal in the second transistor.

6. A driving method of the display device according to claim 1.

7. An electronic device comprising:
the display device according to claim 1; and
a display control device configured to supply image data corresponding to a partial area and image data corresponding to the entire screen to the display device.
